(19) United States
(12) Patent Application Publication
(10) Pub. No.: US 2002/0175915 A1
(43) Pub. Date: Nov. 28, 2002

(54) Internet image projector

(76) Inventor: Hans A. Lichtfuss, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/863,913

(22) Filed: May 23, 2001

(51) Int. Cl. G03B 21/26

(52) U.S. Cl. 345/440

(57) ABSTRACT

The present invention is directed to a projector which includes a network interface for receiving presentation data over a network connection and a projection system for projecting received presentation data onto a projection screen which is separate from the projector and which is disposed so as to reflect the projected image. Preferably, the network interface and projection system are disposed within a single container.

### RELATED APPLICATIONS

The present invention is related to commonly assigned, co-pending, concurrently filed U.S. patent application Ser. No. [Attorney Docket No. 10004914-1], entitled “IMAGE CAPTURING CAMERA AND PROJECTOR DEVICE,” which is hereby incorporated herein by reference.

### TECHNICAL FIELD

The present invention relates in general to the projection of digitally stored images and in particular to the projection of digital image data acquired over a public network.

### BACKGROUND

Where groups of people gather for presentation of images, whether for business or entertainment purposes, it is generally desirable to deploy a device equipped with convenient means for displaying such images on a surface readily visible to all in attendance in a cost-effective manner. Moreover, it is desirable to provide image data to a projector in a convenient manner employing a projector and source of image data which is as flexible and as portable as possible.

Traditional overhead projectors employ slides or transparencies (transparent prints) as sources of image data. The transparent prints are generally illuminated and the resulting illuminated image projected out of a projecting device onto a reflective surface for convenient viewing by one or more persons. Although this approach is simple, straightforward, and relatively inexpensive, numerous limitations are inherent in this approach. First, only fixed images may be used (as opposed to dynamically changing images). Moreover, the source of data must generally be physically carried to each destination or venue at which a display of such data is desired, thereby incurring a risk of loss and/or damage to the transparent prints and the burden of physically transporting the same. Accordingly, the deployment of a more flexible and less cumbersome source of image data is desirable.

One alternative approach involves the use of a scanner in cooperation with a projector to scan non-transparent prints (such as paper printouts of text or image data) into a digital memory and then project the stored image onto a screen for convenient viewing thereof. This approach provides improved flexibility in that paper printouts and other image sources not specifically configured for a particular projector may be converted into a form suitable for projection. However, the problem of being restricted to static images remains. Moreover, resolution of the displayed image may be limited by the quality of the image being scanned and the resolution of the scanner.

A projector may receive video output from a personal computer or other proximately disposed source of video data and project image data received therefrom onto a viewing screen. An external device, such as the afore-mentioned personal computer or other video source would generally be required in order to practice this approach. This approach would generally enable viewing of dynamically changing images included within a prepared presentation. However, where a presentation is embodied on videotape, digital video disk, or other similar format, it is relatively difficult to edit or modify such a presentation. Although a presentation embodied in a computer program may provide for editing and modification of such presentation, display of such a presentation is then rendered dependent upon the availability of a computer at an intended projection site and upon the available computer having computing facilities compatible with demands of the software employed in the presentation as well as communication hardware compatible with a suitable projection system.

Accordingly, it is a problem in the art that transparent prints are limited to presenting static images and that the prints must be carried to each location where the prints are to be viewed.

It is a further problem in the art that projectors equipped with scanners are limited to projecting static images embodied on physical media such as paper.

It is a still further problem in the art that presentations embodied on video tapes or disks are generally difficult to edit or modify once completed.

It is a still further problem in the art that presentations involving projection of data received from a computer generally require the deployment of a computer with software and hardware compatible with projection equipment intended for use at a viewing site.

### SUMMARY OF THE INVENTION

The present invention is directed to a projector which includes a network interface for receiving presentation data over a network connection and a projection system for projecting received presentation data onto a projection screen which is separate from the projector and which is disposed so as to reflect the projected image. Preferably, the network interface and projection system are disposed within a single container.

### BRIEF DESCRIPTION OF THE DRAWING

FIG. 1 depicts a perspective view of a projection apparatus according to a preferred embodiment of the present invention;

FIG. 2 depicts a network connection suitable for exchanging presentation data between a media access site and a one or more user sites according to a preferred embodiment of the present invention; and

FIG. 3 depicts computer apparatus adaptable for use with a preferred embodiment of the present invention.

### DETAILED DESCRIPTION

The present invention is directed to a system and method which provides a flexible and portable projection system for viewing presentations which may include a variety of image data formats and a mechanism for preparing and readily modifying presentation data for subsequent viewing. Moreover, the present invention preferably provides means for conveniently accessing prepared presentations at a variety of projection locations without having to carry cumbersome portable image data storage media or equipment for generating image data communication to a projection system such as a personal computer.

In a preferred embodiment, the present invention combines a projection sub-system with a plurality of presentation data sources from which image and other presentation data may be acquired. Data from such presentation data sources are preferably converted into a graphical display format via the use of a silicon display or LCD (liquid crystal display) and projected onto a viewing surface, which is preferably a projection screen, for viewing by one or more persons. Projection of an image displayed on a silicon display or LCD is preferably aided by supplying light of appropriate intensity and color onto such display.

In a preferred embodiment, the inventive projection apparatus is provided with a network connection enabling direct connection to a public network which may be the Internet or a private network. Preferably, provision is also made for connection of the projection apparatus to individual computing and communication devices, such as, for instance, personal computers, fax machines, printers, keyboards, a computer mouse, personal digital assistants, and mass storage equipment such as those employing magnetic and/or optical storage technology. Where appropriate, both control information and information for projection may be received from such communication devices.

In a preferred embodiment, selected image data sources are disposed within the inventive projection apparatus. A flatbed scanner is preferably included within the inventive apparatus. Employing this scanner, printed paper stock and other materials having suitable surfaces may be scanned, image data collected therefrom, and this data projected onto a projection screen. Provision for inclusion of equipment for reading electronically stored data (both image data and data for controlling the operation of the projection apparatus) may also be made. Preferably, memory card slots are provided in order to enable reading of data from memory cards commonly used in digital cameras, thereby enabling a rapid, convenient, and direct transfer of data from digital cameras and/or digital camcorders to the inventive projection apparatus. Other electronic data reading mechanisms may be included such as, for instance, computer hard disk drives, computer floppy disk drives, Smart card readers, CD-ROM drives, ZIP drives, and DVD drives. In addition to providing image data, such electronic data reading instrumentalities may enable control instructions for controlling a sequence of activity the inventive projection apparatus to be transmitted from a memory card or other portable form of electronic data storage to the projection apparatus, and all such variations are included within the scope of the present invention.

In a preferred embodiment, a service is preferably disposed on a public network, such as the Internet, for enabling users or subscribers to access information on one or more web sites suitable for downloading to the inventive projection apparatus and for viewing on a projection screen. Considerable flexibility and convenience may be provided by such an approach. For instance, upon accessing the appropriate web site, one option would be for the projector to suitably identify a presentation and then download it in its entirety for storage in an appropriately configured storage system within the projector. Such storage may be solid state or in the form of an optical or magnetic drive.

In an alternative embodiment, an entire presentation need not be downloaded all at once. Instead, a user could follow links to different pages within a web site in real time and continuously feed images supplied by access to the Internet site to the projector for projection and viewing. This approach would obviate the need to store an entire presentation and would instead depend upon an available sequence of images on the web site to determine the course of a presentation. Where pages on the web site or media access site have a plurality of pages linked thereto, numerous options may be available for the sequence in which the pages, and images associated therewith, could be presented. Accordingly, use of a media access web site according to the foregoing description preferably enables provision of a presentation wherein both the images included in the presentation and the order in which such images are presented may be flexibly adjusted in real time according to user needs.

In a preferred embodiment, with appropriately authorized access, a user may be enabled to prepare, edit, and otherwise modify a presentation and make such presentation available online to himself or herself and optionally other appropriately authorized users. The inventive projection apparatus may be provided with a default web address which the projection apparatus will access upon issuance of an appropriate command.

Accordingly, it is an advantage of a preferred embodiment of the present invention that the inventive projection apparatus may receive image either static or dynamically changing image data from a variety of electronic media.

It is a further advantage of a preferred embodiment of the present invention that presentations made available on a media access web site may be readily edited and/or upgraded to suit a user's needs.

It is a still further advantage of a preferred embodiment of the present invention that the inventive projection apparatus is self-sufficient, thereby providing a portable and convenient solution for providing graphical presentations without requiring any additional equipment or image storage materials be physically carried to a projection location.

It is a still farther advantage of a preferred embodiment of the present invention that an image may generally be projected onto a reflective screen less expensively than displaying the same image on a CRT (cathode ray tube) screen of equivalent size.

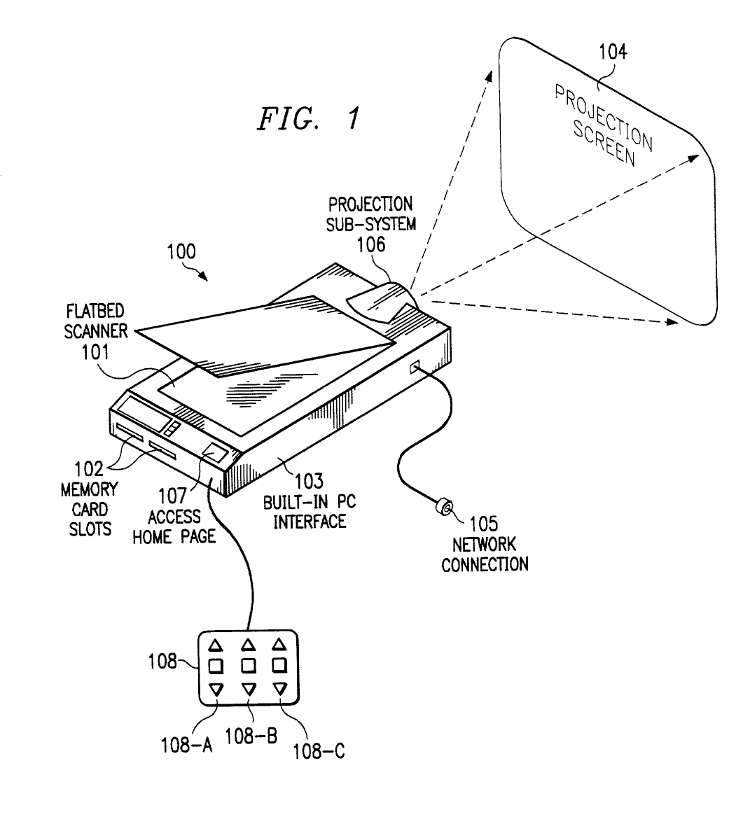

FIG. 1 depicts a perspective view of projection apparatus 100 according to a preferred embodiment of the present invention. In a preferred embodiment, projector 100 is provided with projection sub-system 106 which operates to project images, derived from image data, onto projection screen 104. The inventive projector preferably provides a plurality of communication ports to enable the receipt of image data from a variety of different sources. The inventive projector may optionally be enabled to transmit image data and other forms of data, such as control instructions, to computing and/or communication devices in communication with projector 100. One or more audio speakers, or audio output sockets for driving remote speakers, may optionally be included in projector 100 to enable the playing of audio information in addition to, and possibly concurrently with, image data for display by projection sub-system 106. The presentation of such audio information may take many forms, including but not limited to: speech by itself or describing an accompanying image and music with or without an accompanying image.

Herein, the terms “presentation data” and “projection data” generally correspond to data for use in a presentation which data may include image data (either still or live action video), text data, audio data, and the term “presentation components” generally corresponds to elements of a presentation such as a video clip (or video segment), audio clip (or audio segment), or single still image.

In a preferred embodiment, projector 100 is provided with enough memory to store at least one image so that the image may be displayed even after an image data source is disconnected from projector 100. Still further storage space may be beneficially employed to store numerous images as well as video data, and optionally, sound and other data types. Such storage may be provided in the form of RAM (random access memory), and/or magnetic and/or optical random access storage media such as computer hard disk drives and CD-RW drives (compact disk read-write drives).

In a preferred embodiment, various means for receiving communicated image data are provided with inventive projector 100. Network connection 105, which is preferably an Internet connection, preferably enables projector 100 to send and receive data over a private network or public network such as the Internet. Network connection 105 may be wired, wireless, or a combination thereof. In addition, PC (personal computer) interface connection 103 preferably enables projector 100 to conduct two-way communication with a proximately disposed personal computer, personal digital assistant, or other intelligent device via either a wired or wireless interface. In all cases above, data communication may include image data as well as control data which control data may include instructions indicating a requested sequence of operations for either projector 100 or other device in communication with projector 100. An infrared light or RD (Radio Frequency) communication port could also be deployed within projector 100, and all such variations are included within the scope of the present invention.

In a preferred embodiment, selected image data sources are disposed within projector 100. One or more memory card slots 102 are preferably provided to allow image data stored on memory cards to be rapidly and conveniently transferred into projector 100 and viewed on projection screen 104. Flatbed scanner 101 is preferably included to allow images embodied on paper or other surface suitable for scanning to be transmitted into projector 100 and displayed on projection screen 104 by projection sub-system 106. Moreover, other facilities for transferring image data from portable storage media, such as memory cards, may be deployed within projector 100 including but not limited to: CD-RW drives, DVD (digital video disk) drives, Smart Card readers, computer floppy disk drives, and ZIP drives. Preferably, data transmitted to and from projector 100 employing wired or wireless connections or employing readily portable storage media may include control and instruction data in addition to image data.

In a preferred embodiment, projector 100 is enabled to connect to media access site 206 on a network such as the Internet. Network connection 105 preferably provides a physical connection to enable such network connectivity. Network connection 105 is not limited to any one type of Internet service. Connection services including but not limited to: telephone dial-up, DSL (digital subscriber line), cable, and ISDN (Integrated Services Digital Network) may be employed, and all such variations are included within the scope of the present invention.

In a preferred embodiment, control functionality is provided to enable projector 100 to connect to the Internet or other network. A range of such control functionality may be provided. Where it is desired to provide minimal functionality to minimize cost and complexity of projector 100, projector 100 may be provided with default instructions and/or control sequences for initiating an Internet connection and at least one default web site address or URL (universal resource locator) for commencing a session on the Internet or other network. Access Home Page button 107 on projector 100 preferably causes the Internet connection to be activated if not already in use, and causes an Internet browser employed in conjunction with projector 100 to access a pre-established default home page on the Internet or other network. This pre-established home page address may be modified as needed based on any modifications of the Internet address of the home page. If needed, more than one home page may be provided, and provision may be made for a user to select which home page from a group of available home pages to use at any given time, for a particular presentation, and all such variations are included within the scope of the present invention.

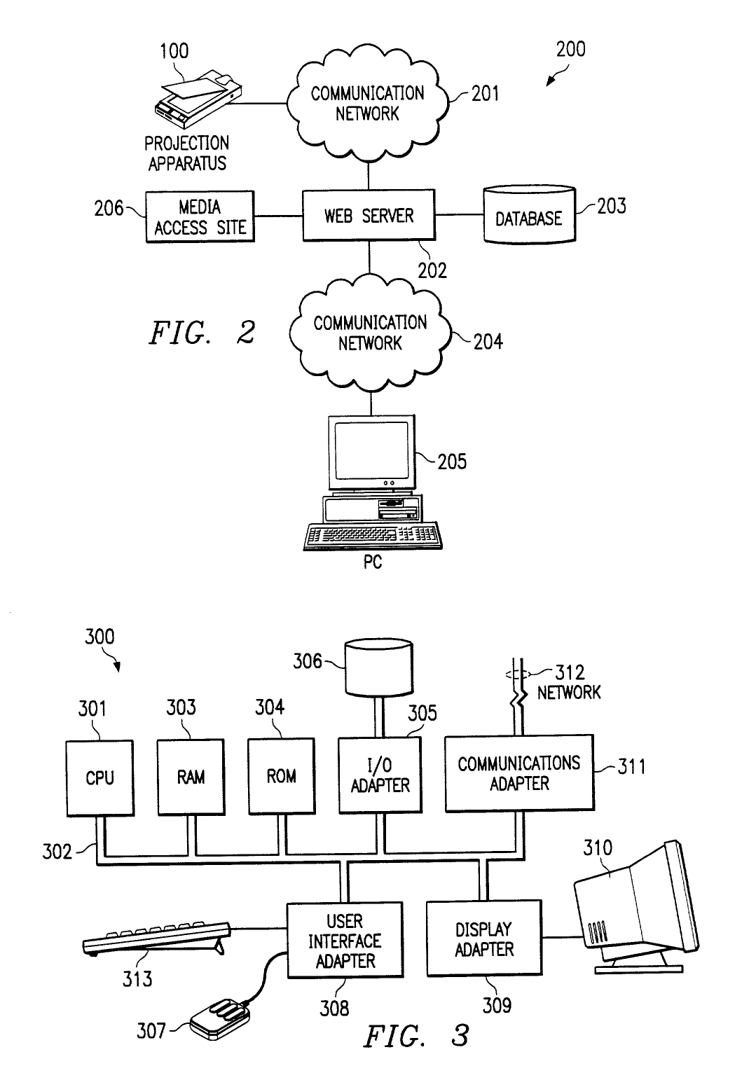

FIG. 2 depicts a network configuration suitable for acquiring presentation data over a public network according to a preferred embodiment of the present invention. Rather than employing presentation data embodied on static graphic images, such as transparent slides, as was practiced in the prior art, or even on portable forms of electronic data storage, such as memory cards, floppy disks, the provision of network connection 105 preferably provides for flexibility in the composition, display, editing, and modification of presentation data which may be stored on web server 202 or in a location accessible to web server 202, such as database 203. Flexibility is also provided with respect to the mobility of a display or demonstration derived from such presentation data. Once presentation data is made available on the Internet, a demonstration may be made from such presentation data at any location able to access the Internet, thereby providing for uniformity in the demonstrations formed from the stored presentation data, and enhanced portability of materials needed for such presentation since portable storage media, such as memory cards and floppy disks, would generally not have to physically carried to various demonstration or display venues.

In a preferred embodiment, activation of the “access home page” (hereafter “home”) function 107 on projector 100 operates to enable projector 100 to access a media access site 206 made available on web server 202 over communication network 201. Preferably, home function 107 operates to transmit a default world wide web address to web server 202 in order to bring up an initial or home web page, within a media access site 206, from which a presentation may be selected for display by projector 100. The default web page address embedded in projector 100 is preferably editable within projector 100 if the address of the pertinent web page changes.

In a preferred embodiment, users browsing the web are appropriately screened for access to the presentation data home page in order to limit such access to properly authorized users. Authorization may be awarded based on a fee-based subscription service where the service is commercially operated, or to employees or other authorized users of a service provided without charge. Projector 100 may be provided with a password that is automatically generated upon activating the home function 107. As with the default web page address preferably provided in projector 100, the password is preferably editable by a user with proper authorization.

In a preferred embodiment, the inventive Internet-accessible presentation system may be accessed, downloaded, and displayed at any location having internet access and proper access authorization, and similarly, is preferably able to be edited from any location having both Internet access and appropriate editing authorization. Provision of such editing authorization may be accomplished by assigning higher level authority to selected group of users having a need and right to modify stored presentations. These select users are preferably awarded one or more passwords enabling such users to modify a presentation instead being merely able to download the same. Passwords for users not intended to have editing rights preferably disable users from modifying the online presentations.

Preferably, editing or updating of presentations may be accomplished either prior to displaying a presentation at a venue site. Alternatively, editing of a presentation could be conducted concurrently with the presentation, either at the venue site itself or at a location remote from the venue site.

In a preferred embodiment, a presentation accessible on server 202 may be updated employing personal computer 205 via communication network 204. A properly authorized user at personal computer 205 is preferably able to upload text, audio, and/or video data to web server 202 via network 204 and appropriately sequence the presentation of such data so as to form a coherent presentation for subsequently accessing and downloading by projection apparatus 100. The use of personal computer 205 is exemplary. Other computers at different sites, as well as other types of computing equipment may be employed to create and edit presentations for subsequent accessing on web server 202. While network 204 is depicted in FIG. 2 as being distinct from network 201, networks 201 and 204 may be one and the same.

In a preferred embodiment, a plurality of data and media types may be employed on the media access web site, downloaded to a user venue, venue site, or user site, and played or displayed for viewing and listening at such user site. Preferably, presentation data made available on a media access site 206 on web server 202 may include data types including but not limited to: still image data, live action video data, animation image data, text data, and audio data. Preferably, presentations may include data other than data for display, such as data for controlling the operation of a display device, data describing a sequence of images, and other instructions for managing the presentation of display information.

In a preferred embodiment, means are preferably provided for browsing through media access site 206 by projector 100 and for navigating through images and other presentation components. One means for providing such browsing and navigation capability is control panel 108 shown in FIG. 1. Control panel 108 may be linked to projector 100 via a wired or wireless interface. Three separate sets of controls shown as 108-A through 108-C are shown. However, it will be appreciated that any number of such sets of controls may be included in control panel 108. In an alternative embodiment, the control input enabled by control panel 108 may be provided by other devices having either wired or wireless communication links to projector 100 including but not limited to personal digital assistants, cell phones, and wireless remote control devices (such as those used for audio/video equipment). Moreover, control input to projector 100 may be provided from a remote location over the Internet or other appropriate network.

In a preferred embodiment, the column of buttons pointed to by reference numeral 108-A may be employed to navigate through a list of images or other presentation components such as video clips or audio sequences. The button having the upward pointing arrow could be used to move forward through a list while the button having the downward pointing arrow could be used to move backward through the list. If necessary, the central button in the 108-A column could be depressed to issue a command to run, or show, a highlighted presentation component. Such an activation operation would be relevant where the navigation process merely points to representations of each presentation component rather than automatically displaying, playing, or running each such component in the process of navigating.

In a preferred embodiment, in like manner to the operation of control button column 108-A above, column 108-B could be used to navigate through a list of web page links displayed on a page within media access site 206. The top button in column 108-B could be used to move upward in such a list, the bottom button to move downward through the list, and the center button used to activate a link currently being highlighted or pointed to by the browser. Additional columns of buttons, such as column 108-C, could be included in the design of control panel 108 to serve future needs of projector 100 which are not currently identified.

An alternative mechanism for providing data entry to projector 100 is to deploy a pad for handwriting recognition either on projector 100 or on a device in communication therewith. A user could write out web addresses for the projector to access, transmit instructions to projector 100 and/or the web site, and/or submit text and/or graphical data for interpretation, processing, and ultimate presentation by projector 100 on projection screen 104. Such handwritten input to projector 100 could be provided using a device customized for interaction with projector 100 or employing a personal digital assistant such as a Palm Pilot® in communication with projector 100. Where a number of people are present at a projection site at once, those in attendance could beneficially combine their efforts towards completing a common task by contributing handwritten contributions of text or graphical data to a single projected image simultaneously viewable to all contributors as well as to other persons in attendance. This approach could, for example, enable designers to collaborate on the generation of a figure or drawn image to which all could contribute in real-time.

In a preferred embodiment, a plurality of options exist for presenting a complete presentation employing projector 100 involving various combinations of automation and user input for determining the content and order of presentation of various components of a presentation. Employing a highly automatic approach, a user could prepare a presentation which is complete without further input and which fully defines an order in which various presentation components are to be presented. It will be appreciated that in the case of audio and video or still image data, audio and image data may be presented concurrently. Such a presentation could be downloaded all at once in its entirety to a storage apparatus disposed within, or in communication with, projector 100 and then presented at the projector site. The presentation could be run on the web site and the images and other presentation components displayed and/or played (in the case of audio data) as the presentation progresses, without downloading the presentation into a storage apparatus disposed within or in communication with projector 100.

In another preferred embodiment, a presentation developer may set up a presentation having a default path established which runs from a starting point to a conclusion of a presentation but which enables a user to exercise options at selected points as to which of a plurality of paths to follow. A still more manual approach would introduce a user to set of options at various points throughout a presentation without indicating a default selection. Options expressed by the user in this situation could be permitted to fundamentally alter the path of a presentation.

An example is considered wherein a history exhibit having still images, video clips, and optionally, audio clips is available on server 202. The example begins with a set of available images of families as of 1700. Presentation components are preferably made available for a selection of individual figures within these families. After a presentation including information on each these selected figures, the user is preferably given a choice as to which of several possible family lines to trace to the present time. After a user makes a selection, the presentation preferably continues with a presentation of information on a selection of individual people included within the family line selected. Preferably, the presentation pauses after information has been presented on selected figures for a particular generation and offers the user/presentation viewer to select a desired path to follow for a next segment of the presentation. In this manner, a presentation may flow from beginning to end with the user entering data to help determine the course and contents of the presentation in an environment in which a large number of paths could be followed. It may be seen that this approach allows a user to customize an individual presentation for his or her own purposes even though the presentation data initially presented on server 202 is the same for users accessing media access site 206.

In situations where projector 100 is in communication with an external network, the user could browse the network “live” (or, concurrently with a presentation) to find answers to questions presented by viewers as the presentation progresses. Furthermore, since the network connection is typically bidirectional, a remotely located resource, such as a human being or a computer using speech recognition, could monitor the speaker, or the audience, and in response to questions (either from a local or remotely located viewer), research data on the World Wide Web or other resource, and have such data displayed employing projector 100. Thus, an associate back home could provide new information, or updated information, perhaps using personal computer 205.

In a preferred embodiment, where a presentation is to be advanced under human control rather than according to completely programmed sequence of presentation components, several options are available for exercising such control. A user present at a projection site could control the presentation using control panel 108 or alternative control device. Alternatively, a person located remotely from the projection site could control the presentation by accessing media access site 206, appropriately logging on, and issuing commands from the remote location to control the flow of a presentation.

FIG. 3 illustrates computer system 300 adaptable for use with a preferred embodiment of the present invention. Central processing unit (CPU) 301 is coupled to system bus 302. The CPU 301 may be any general purpose CPU, such as an Hewlett Packard PA-8200. However, the present invention is not restricted by the architecture of CPU 301 as long as CPU 301 supports the inventive operations as described herein. Bus 302 is coupled to random access memory (RAM) 303, which may be SRAM, DRAM, or SDRAM. ROM 304 is also coupled to bus 302, which may be PROM, EPROM, or EEPROM. RAM 303 and ROM 304 hold user and system data and programs as is well known in the art.

Bus 302 is also coupled to input/output (I/O) adapter 305, communications adapter card 311, user interface adapter 308, and display adapter 309. The I/O adapter 305 connects to storage devices 306, such as one or more of hard drive, CD drive, floppy disk drive, tape drive, to the computer system. Communications adapter 311 is adapted to couple the computer system 300 to a network 312, which may be one or more of local area network (LAN), wide-area network (WAN), Ethernet or Internet network. User interface adapter 308 couples user input devices, such as keyboard 313 and pointing device 307, to the computer system 300. The display adapter 309 is driven by CPU 301 to control the display on display device 310.

What is claimed is:

1. A projector, comprising:
a network interface for receiving presentation data over a network connection; and
a projection system for projecting said received presentation data onto a projection screen separate from said projector and disposed so as to reflect said projected received presentation data, wherein said network interface and said projection system are disposed within a single container.

2. The projector of claim 1 wherein said presentation data is multimedia presentation data.

3. The projector of claim 1 further comprising:
a memory card reader.

4. The projector of claim 1 further comprising:
a flatbed scanner for providing scanned data to said projection system.

5. The projector of claim 1 further comprising:
a communication interface to a personal computer.

6. The projector of claim 5 wherein said personal computer may be local to said projector or may be connected to said personal computer via said network interface.

7. The projector of claim 5 wherein said communication interface is a wireless interface.

8. A method for providing a presentation, the method comprising the steps of:
identifying a media access site on a bidirectional network;
accessing said media access site;
downloading at least one image from said media access site; and
projecting downloaded ones of said images at a venue site local to said projecting; and
performing said steps of accessing, downloading, and projecting employing a single apparatus.

9. The method of claim 8 wherein said identifying step is also performed within said single apparatus.

10. The method of claim 8 wherein said step of projecting comprises the step of:
projecting onto a reflective screen facing said apparatus.

11. The method of claim 8 wherein said network is the Internet.

12. The method of claim 8 wherein said network is a link to a specific site remote from said presentation.

13. The method of claim 8 wherein said downloading step comprises the step of:
downloading a substantially complete presentation.

14. The method of claim 13 wherein said projecting step comprises the step of:
projecting said substantially complete presentation.

15. The method of claim 8 further comprising the step of:
accessing a succession of linked pages on said media access site under control of instructions from said single apparatus.

16. The method of claim 15 further comprising the step of:
downloading at least one image from selected linked pages of said accessed succession of linked pages; and
projecting said at least one downloaded image from said selected linked pages.

17. The method of claim 8 further comprising the step of:
acquiring presentation data from an optical scanner disposed within said single apparatus.

18. The method of claim 8 further comprising the step of:
acquiring presentation data from a memory card positioned within said single apparatus.

19. The method of claim 8 further comprising the step of:
enabling presentation data on said media access site to be edited by a user in communication with said network.

20. The method of claim 19 wherein said editing user is local to said presentation.

21. The method of claim 19 wherein said editing user is remote from said presentation.

22. A system for viewing a presentation, the system comprising:
means at a projection site for receiving presentation data over a bi-directional network connection from a media access site;
means for controlling a presentation of said received presentation data; and
means for projecting said controlled presentation at a projection site.

23. The system of claim 22 further comprising:
means controlled by a user of said presentation data for modifying said presentation data on said media access site; and
means for storing said modified presentation data on said media access site.

24. The system of claim 23 wherein said modifying means comprises:
means for modifying said presentation data from a location remote from said media access site.

25. The system of claim 22 wherein said receiving means comprises:
means for receiving selected ones of presentation components disposed on said media access site.
